(19) United States
(12) Patent Application Publication
(10) Pub. No.: US 2025/0086471 A1
(43) Pub. Date: Mar. 13, 2025

(54) GENERATING SMALL LANGUAGE MODEL VIA TWO-PHASE TRAINING

(71) Applicant: Microsoft Technology Licensing, LLC, Redmond, WA (US)

(72) Inventors: Sébastien BUBECK, Seattle, WA (US); Ronen ELDAN, Seattle, WA (US); Allison DEL GIORNO, Kirkland, WA (US); Suriya GUNASEKAR, Seattle, WA (US); Yin Tat LEE, Seattle, WA (US); Yuanzhi Li, Monroe, WA (US); Mojan JAVAHERIPI, San Diego, CA (US)

(73) Assignee: Microsoft Technology Licensing, LLC, Redmond, WA (US)

(21) Appl. No.: 18/733,226

(22) Filed: Jun. 4, 2024

Related U.S. Application Data
(60) Provisional application No. 63/537,770, filed on Sep. 11, 2023.
(60) Provisional application No. 63/637,874, filed on Apr. 23, 2024.

(51) Int. Cl. G06N 3/091; G06N 3/0475

(52) U.S. Cl. CPC G06N 3/091; G06N 3/0475

(57) ABSTRACT

Systems and methods for generating a small language model are provided. In particular, a computing device may obtain a general dataset including a plurality of general data, annotate a subset of the general dataset based on one or more classifier metrics indicative of a quality of the general dataset, train a classifier based on the annotated subset of the general dataset and the one or more classifier metrics, analyze each general data of the general dataset to determine a score for each of the one or more classifier metrics associated with the respective general data using the trained classifier, generate a filtered general dataset by filtering the general dataset based on one or more filters, train the small language model with the filtered general dataset, generate a synthetic dataset for refining the small language model, and train the small language model with the synthetic dataset.

### CROSS-REFERENCE TO RELATED APPLICATIONS

This application claims priority to U.S. Provisional Patent Application 63/537,770, filed Sep. 11, 2023, and U.S. Provisional Patent Application 63/637,874, filed Apr. 23, 2024, which are hereby incorporated by reference in its entirety.

### BACKGROUND

Over the past few years, Large Language Models (LLMs) have transformed the field of Natural Language Processing. More broadly, they hold the promise of a paradigm shift for human-computer interaction. These advancements have far-reaching economic implications, as well as the potential to redefine conceptual frameworks of artificial intelligence and perhaps even cognition itself. LLMs uses a large scale of parameters and tokens for training data in achieving high levels of capability. The improvement from one generation of LLMs to the next seems at the moment to primarily stem from scale, with the most powerful models nearing trillions of parameters and trillion of tokens for training data. However, the cost of training, deploying, and maintaining such large models may be substantial. From a responsible artificial intelligence (AI) standpoint, the energy consumption of large-scale models is becoming an increasing concern, as is the question of how controllable or governable these large models can be.

It is with respect to these and other general considerations that embodiments have been described. Also, although relatively specific problems have been discussed, it should be understood that the embodiments should not be limited to solving the specific problems identified in the background.

### SUMMARY

In accordance with examples of the present disclosure, a small language model (SLM) is generated via a two-phase training to achieve similar capabilities as large language models (LLMs). The small language model is a type of generative machine leaning model that are trained with smaller training data with fewer parameters compared to LLMs. Specifically, the two-phase training includes a first training phase and a second training phase. The first training phase involves generating a filtered general dataset from various sources and training the small language model with the filtered general dataset. The second training phase involves generating a synthetic dataset using prompts and training the small language model with the synthetic dataset. By curating the training data through the two-phase training from two separate sources, the small language model is trained with data that satisfy certain quality suitable for understanding common sense reasoning and general knowledge of the world and performing certain application and reasoning tasks (e.g., common sense or logical reasoning).

In accordance with at least one example of the present disclosure, a method for generating a small language model is provided. The method may include obtaining a general dataset, the general dataset including a plurality of general data, annotating a subset of the general dataset based on one or more classifier metrics indicative of a quality of the general dataset, the subset of the general dataset being representative of the general dataset, training a classifier based on the annotated subset of the general dataset and the one or more classifier metrics, analyzing each general data of the general dataset to determine a score for each of the one or more classifier metrics associated with the respective general data using the trained classifier, generating a filtered general dataset by filtering the general dataset based on one or more filters, the one or more filters indicative of threshold scores for corresponding classifier metrics, training the small language model with the filtered general dataset, generating a synthetic dataset for refining the small language model, and subsequent to training the small language model with the filtered general dataset, training the small language model with the synthetic dataset.

In accordance with at least one example of the present disclosure, a computing device for generating a small language model is provided. The computing device may include a processor and a memory having a plurality of instructions stored thereon that, when executed by the processor, causes the computing device to generate a small language model, the method comprising: obtain a general dataset, the general dataset including a plurality of general data, annotate a subset of the general dataset based on one or more classifier metrics indicative of a quality of the general dataset, the subset of the general dataset being representative of the general dataset, train a classifier based on the annotated subset of the general dataset and the one or more classifier metrics, analyze each general data of the general dataset to determine a score for each of the one or more classifier metrics associated with the respective general data using the trained classifier, generate a filtered general dataset by filtering the general dataset based on one or more filters, the one or more filters indicative of threshold scores for corresponding classifier metrics, train the small language model with the filtered general dataset, generate a synthetic dataset for refining the small language model, and subsequent to training of the small language model with the filtered general dataset, train the small language model with the synthetic dataset.

In accordance with at least one example of the present disclosure, a computer storage medium is provided. The computer storage medium stores computer-executable instructions that when executed cause at least one processor to perform operations. The operations include obtaining a general dataset, the general dataset including a plurality of general data, annotating a subset of the general dataset based on one or more classifier metrics indicative of a quality of the general dataset, the subset of the general dataset being representative of the general dataset, training a classifier based on the annotated subset of the general dataset and the one or more classifier metrics, analyzing each general data of the general dataset to determine a score for each of the one or more classifier metrics associated with the respective general data using the trained classifier, generating a filtered general dataset by filtering the general dataset based on one or more filters, the one or more filters indicative of threshold scores for corresponding classifier metrics, training the small language model with the filtered general dataset, generating a synthetic dataset for refining the small language model, and subsequent to training the small language model with the filtered general dataset, training the small language model with the synthetic dataset.

This Summary is provided to introduce a selection of concepts in a simplified form, which is further described below in the Detailed Description. This Summary is not intended to identify key features or essential features of the claimed subject matter, nor is it intended to be used to limit the scope of the claimed subject matter. Additional aspects, features, and/or advantages of examples will be set forth in part in the following description and, in part, will be apparent from the description, or may be learned by practice of the disclosure.

### BRIEF DESCRIPTION OF THE DRAWINGS

Non-limiting and non-exhaustive examples are described with reference to the following Figures.

FIG. 1 depicts a block diagram of an example of a two-phase training of a small language model in accordance with examples of the present disclosure;

FIG. 2 depicts a block diagram of an example of an operating environment in which a language model generator may be implemented in accordance with examples of the present disclosure;

FIGS. 3A and 3B depict a flowchart of an example method of generating a small language model in accordance with examples of the present disclosure;

FIGS. 4A and 4B illustrate overviews of an example generative machine learning model that may be used in accordance with examples of the present disclosure;

FIG. 5 is a block diagram illustrating example physical components of a computing device with which aspects of the disclosure may be practiced;

FIG. 6 is a simplified block diagram of a computing device with which aspects of the present disclosure may be practiced; and

FIG. 7 is a simplified block diagram of a distributed computing system in which aspects of the present disclosure may be practiced.

### DETAILED DESCRIPTION

In the following detailed description, references are made to the accompanying drawings that form a part hereof, and in which are shown by way of illustrations specific embodiments or examples. These aspects may be combined, other aspects may be utilized, and structural changes may be made without departing from the present disclosure. Embodiments may be practiced as methods, systems, or devices. Accordingly, embodiments may take the form of a hardware implementation, an entirely software implementation, or an implementation combining software and hardware aspects. The following detailed description is therefore not to be taken in a limiting sense, and the scope of the present disclosure is defined by the appended claims and their equivalents.

Over the past few years, Large Language Models (LLMs) have transformed the field of Natural Language Processing. More broadly, they hold the promise of a paradigm shift for human-computer interaction. These advancements have far-reaching economic implications, as well as the potential to redefine conceptual frameworks of artificial intelligence and perhaps even cognition itself. LLMs uses a large scale of parameters and tokens for training data in achieving high levels of capability. The improvement from one generation of LLMs to the next seems at the moment to primarily stem from scale, with the most powerful models nearing trillions of parameters and trillion of tokens for training data. However, the cost of training, deploying, and maintaining such large models may be substantial. From a responsible artificial intelligence (AI) standpoint, the energy consumption of large-scale models is becoming an increasing concern, as is the question of how controllable or governable these large models can be.

In accordance with examples of the present disclosure, a small language model (SLM) is generated via a two-phase training to achieve similar capabilities as large language models (LLMs). The small language model is a type of generative machine leaning model that are trained with smaller training data with fewer parameters compared to LLMs. Specifically, the two-phase training includes a first training phase for teaching the small language model general knowledge and language understanding and a second training phase for teaching the small language model logical reasoning and various niche skills. The first training phase involves generating a filtered general dataset from various sources (e.g., web sources) and training the small language model with the filtered general dataset. The second training phase involves generating a synthetic dataset using prompts and training the small language model with the synthetic dataset. By curating the training data through the two-phase training from two separate sources, the small language model is trained with data that satisfy certain quality suitable for understanding common sense reasoning and general knowledge of the world and performing certain application and reasoning tasks (e.g., common sense or logical reasoning).

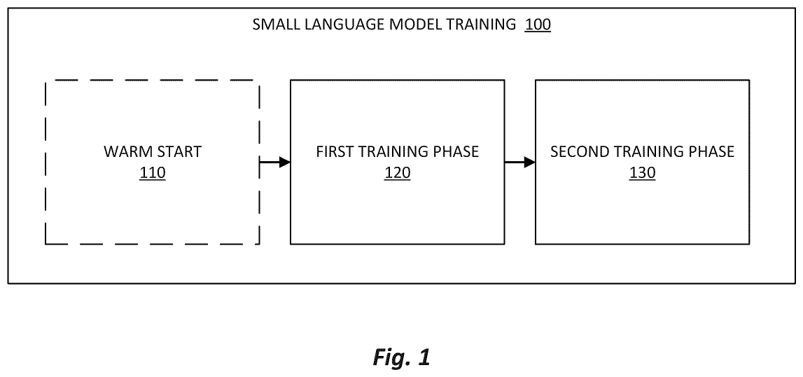

Referring now to FIG. 1, a block diagram of an example of a two-phase training of a small language model in accordance with examples of the present disclosure is provided. The two-phase training of the small language model 100 includes a first training phase 120 and a second training phase 130. As described further below, by curating the training data through two phases of training from two separate sources, the small language model is trained with data that satisfy certain quality suitable for understanding common sense reasoning and general knowledge of the world and performing certain application and reasoning tasks (e.g., common sense or logical reasoning).

In some embodiments, prior to two-phase training, the small language model training may warm start 110 by combining trained weights with new initialized weights. For example, the trained weights from an existing trained model may be copied into the new small language model. In some embodiments, a tiling approach may be used to copy the weights between different dimensions of models to ensure that the weights follow the magnitude distribution of the previous small language model and that the structure of the weight matrices is enforced. By doing so, the warm start 110 may jumpstart on the training of a new model and have the knowledge transfer between the existing and new models to achieve a higher level of performance with less amount of training needed for the new model. This saves computational resources and improves generalizability when training the small language model.

The first training phase 120 involves generating a filtered general dataset and training the small language model with the filtered general dataset. To generate the filtered general dataset, a general dataset including a plurality of general data is obtained from various sources (e.g., web sources). Once the general dataset is obtained, a subset of the general dataset that represents the general dataset is selected and an annotated version of the subset of the general dataset is generated based on one or more classifier metrics indicative of a quality of the subset of the general dataset. To do so, a generative transformer is used for annotations on the quality of the subset of the general dataset based on one or more classifier metrics. For example, the generative transformer may be a language model (e.g., a large language model) or any generative machine learning model capable of annotating data with specific attributes or features. The one or more classifier metrics are specific attributes or features associated with the subset of the general dataset. For example, the one or more classifier metrics include, but not limited to, factual knowledge, everyday knowledge, scientific knowledge, human behavior, toxicity, completeness, obscenity, obscurity, commonality, reasoning, promotional content, and/or unwanted content. In the illustrative embodiment, each general data of the subset of the general dataset is annotated with a score for each classifier metric of the one or more classifier metrics using the generative transformer.

Upon annotating the subset of the general dataset, a classifier is trained using the annotated subset of the general dataset. The trained classifier is configured to predict quality of data based on the one or more classifier metrics. For example, the quality of data may be represented by a score for each classifier metric. Once the classifier is trained, each general data of the general dataset is analyzed to determine a score for each classifier metric associated with the respective general data using the trained classifier. Based on the scores of the general data, one or more filters for filtering the general dataset are generated. Each filter indicates a threshold score for a respective classifier metric. In other words, the one or more filters may be used to filter the general dataset to select general data from the general dataset that have with certain attributes or features for training the small language model.

Once the one or more filters are generated, the filtered general dataset is generated by filtering the general dataset using the one or more filters. The filtered general dataset is a subset of the general dataset that satisfies a predefined level of quality. As described above, each filter is associated with a respective classifier metric. In aspects, one or more filters are selected to obtain those general data that have certain attributes or features for training the small language model. The filtered general dataset is used to train the small language model in the first training phase 120.

The second training phase 130 involves generating a synthetic dataset and training the small language model with the synthetic dataset. The synthetic dataset is “textbook-like” data that is created for the purposed of teaching common sense reasoning and general knowledge of the world (e.g., science, daily activities, theory of mind, etc.). For example, specific topics may be selected to seed the generation of the synthetic data.

To do so, one or more deficit skills in the small language model are identified. It should be appreciated that the term deficit skill means any skill or topic that may boost in the capability of the small language model. Once the one or more deficit skills are identified, one or more data formats to address the one or more deficit skills are determined and one or more prompts are obtained to create the one or more data formats. Additionally, sources of randomization and diversity may be injected into the one or more prompts. Based on the one or more prompts, the synthetic dataset is generated using a generative transformer. For example, the generative transformer may be any generative machine learning model (e.g., a large language model) capable of generating data based on a prompt. In aspects, the synthetic dataset is designed to provide and boost certain skills in the small language model. The filtered general dataset is used to train the small language model in the second training phase 130.

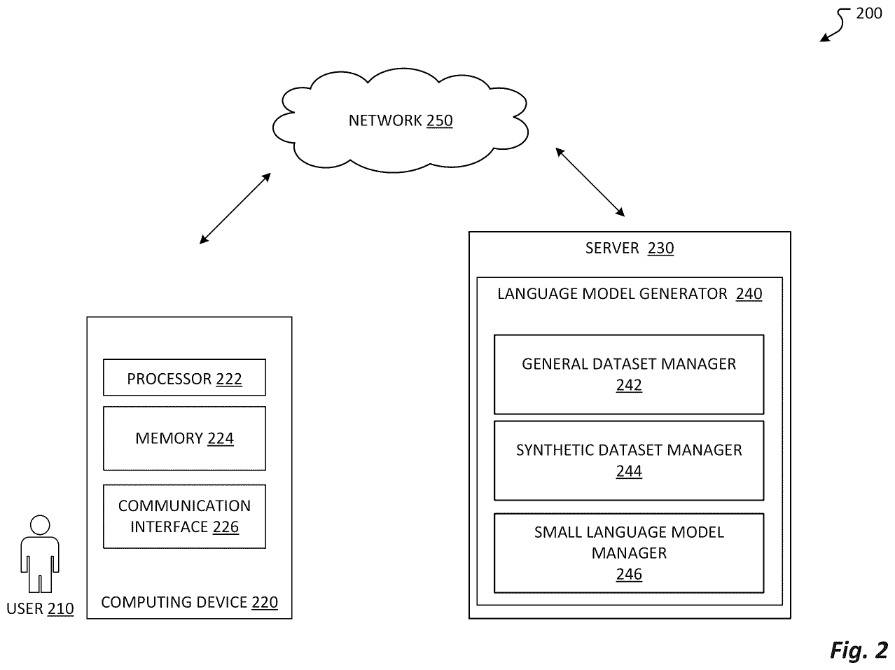

FIG. 2 depicts a block diagram of an example of an operating environment 200 in which a language model generator may be implemented in accordance with examples of the present disclosure. To do so, the operating environment 200 includes a server 230 and a computing device 220 that is communicatively coupled to the server 230 via a network 250. The network 150 may include any kind of computing network including, without limitation, a wired or wireless local area network (LAN), a wired or wireless wide area network (WAN), and/or the Internet. The server 230 may be, but is not limited to, a computer, a notebook, a laptop, a mobile device, a smartphone, a tablet, a portable device, or any other suitable computing device that is capable of executing the language model generator 240. Additionally, the computing device 220 associated with a user 210 includes a processor 222, a memory 224, and a communication interface 226. The computing device 220 may be, but is not limited to, a computer, a notebook, a laptop, a mobile device, a smartphone, a tablet, a portable device, a wearable device, or any other suitable computing device that is capable of communicating with the server 230.

The server 230 includes the language model generator 240, which is configured to generate a small language model trained to understand common sense reasoning and general knowledge of the world for performing reasoning tasks (e.g., common sense or logical reasoning). To do so, the language model generator 240 further includes a general dataset manager 242, a synthetic dataset manager 244, and a small language model manager 246.

The general dataset manager 242 is configured to generate a filtered general dataset to be used during the first training phase of the small language model. To do so, the general dataset manager 242 is configured to obtain a general dataset from various sources (e.g., web sources). The general dataset includes a plurality of general data. Once the general dataset is obtained, the general dataset manager 242 is configured to select a subset of the general dataset that represents the general dataset and generate an annotated version of the subset of the general dataset based on one or more classifier metrics indicative of a quality of the subset of the general dataset. To do so, a generative transformer is used for annotations on the quality of the subset of the general dataset based on one or more classifier metrics. For example, the generative transformer may be a language model (e.g., a large language model) or any generative machine learning model capable of annotating data with specific attributes or features. The one or more classifier metrics are specific attributes or features associated with the subset of the general dataset. For example, the one or more classifier metrics include, but not limited to, factual knowledge, everyday knowledge, scientific knowledge, human behavior, toxicity, completeness, obscenity, obscurity, commonality, reasoning, promotional content, and/or unwanted content. In the illustrative embodiment, the general dataset manager 242 is configured to annotate each general data of the subset of the general dataset with a score for each classifier metric of the one or more classifier metrics using the generative transformer. For example, the score may be on a scale of one to ten with one being the lowest and ten being the highest. For example, a particular general data of the subset of the dataset may be annotated with 2/10 score for a toxicity level and 3/10 score for an obscenity level.

Upon annotating the subset of the general dataset, the general dataset manager 242 is configured to train a classifier using the annotated subset of the general dataset. The trained classifier is configured to predict quality of data based on the one or more classifier metrics. For example, the quality of data may be represented by a score for each classifier metric. Once the classifier is trained, the general dataset manager 242 is further configured to analyze each general data of the general dataset. Specifically, the general dataset manager 242 is configured to analyze each general data to determine a score for each classifier metric associated with the respective general data using the trained classifier.

Based on the scores of the general data, the general dataset manager 242 is configured to generate one or more filters for filtering the general dataset. Each filter indicates a threshold score for a respective classifier metric. In other words, the one or more filters may be used to filter the general dataset to select general data from the general dataset that have with certain attributes or features for training the small language model. For example, a toxicity filter may be defined with a threshold score for toxicity of content of 2/10. In other words, when the filter for toxicity is applied, any general data that has content that have a toxicity level higher than 2 will be filtered out, and only those general data that has content that have the toxicity level of 1 and 2 will remain.

Once the one or more filters are generated, the general dataset manager 242 is configured to generate the filtered general dataset. Specifically, the general dataset manager 242 is configured to generate the filtered general dataset by filtering the general dataset using the one or more filters. The filtered general dataset is a subset of the general dataset that satisfies a predefined level of quality. As described above, each filter is associated with a respective classifier metric. In aspects, one or more filters are selected to obtain those general data that have certain attributes or features for training the small language model.

The synthetic dataset manager 244 is configured to generate a synthetic dataset to be used during the second training phase of the small language model. The synthetic dataset is “textbook-like” data that is created for the purposed of teaching common sense reasoning and general knowledge of the world (e.g., science, daily activities, theory of mind, etc.). For example, specific topics may be selected to seed the generation of the synthetic data.

To do so, the synthetic dataset manager 244 is configured to identify one or more deficit skills in the small language model. It should be appreciated that the term deficit skill means any skill or topic that may boost in the capability of the small language model. The synthetic dataset manager 244 is further configured to determine one or more data formats to address the one or more deficit skills and obtain one or more prompts to create the one or more data formats. Additionally, the synthetic dataset manager 244 is configured to inject sources of randomization and diversity into the one or more prompts.

The synthetic dataset manager 244 is configured to generates the synthetic dataset based on the one or more prompts using a generative transformer. For example, the generative transformer may be any generative machine learning model (e.g., a large language model) capable of generating data based on a prompt. In aspects, the synthetic dataset is designed to provide and boost certain skills in the small language model. To do so, the generative transformer is prompted to synthesize textbook-style content concerning the skills that require to be boosted. For example, detailed lists of topics, subtopics, keywords, as well as content, related to those skills, that was filtered from other sources such as web pages may be provided and used as a seed to the generative transformer. The seed is shuffled and combined with styles, use-cases, user roles, and other sources of randomness that give rise to diverse ways of presenting the content. All of these may be combined as an input into the generative transformer's prompt in different random combinations. Output of the generative transformer may then be integrated to generate the synthetic dataset.

The small language model manager 246 is configured to perform the two-phase training to train a small language model. Specifically, the small language model manager 246 is configured to train the small language model with the filtered general dataset during the first training phase and with the synthetic dataset during the second training phase. By curating the training data for the small language model, the small language model manager 246 is configured to train the small language model with data that satisfies certain quality suitable for certain application. For example, the small language model manager 246 may reduce toxic and biased content among the general dataset and the synthetic dataset. In other words, two separate sources of training data in used over two-phase training to train the small language model to understand common sense reasoning and general knowledge of the world for performing reasoning tasks (e.g., common sense or logical reasoning).

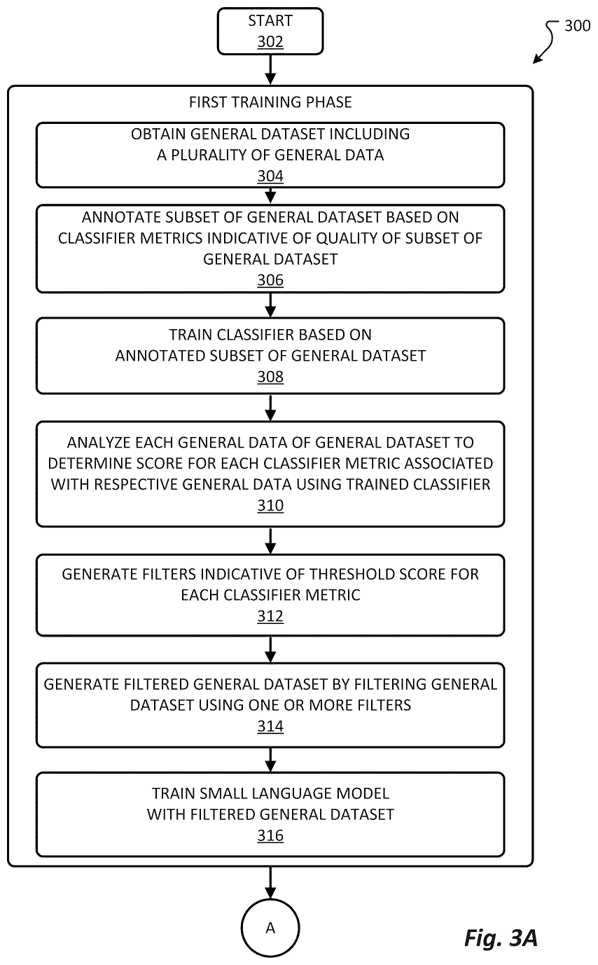

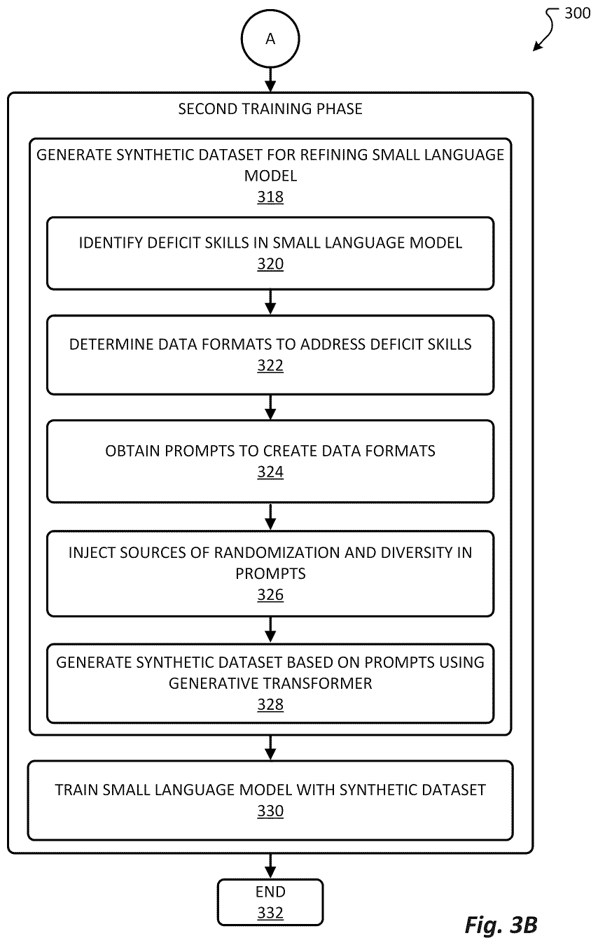

Referring now to FIGS. 3A and 3B, a method 300 for generating a small language model via a two-phase training in accordance with examples of the present disclosure is provided. A general order for the steps of the method 300 is shown in FIGS. 3A and 3B. Generally, the method 300 starts at 302 and ends at 332. The method 300 may include more or fewer steps or may arrange the order of the steps differently than those shown in FIGS. 3A and 3B. In the illustrative aspect, the method 300 is performed by a computing device (e.g., a server 230). However, it should be appreciated that one or more steps of the method 300 may be performed by another device (e.g., a computing device 220). Specifically, in some aspects, the method 300 may be performed by a language model generator (e.g., 240) executed on the server 230. The server 230 may be, but not limited to, a computer, a notebook, a laptop, a mobile device, a smartphone, a tablet, a portable device, or any other suitable computing device that is capable of executing the language model generator 240 to generate and train a small language model. The computing device 220 may be, but not limited to, a computer, a notebook, a laptop, a mobile device, a smartphone, a tablet, a portable device, a wearable device, or any other suitable computing device that is capable of communicating with the server 230.

The method 300 can be executed as a set of computer-executable instructions executed by a computer system and encoded or stored on a computer readable medium. For example, the set of computer-executable instructions stored on a storage device may cause a computing device (e.g., a server 230) to perform the method 300. Further, the method 300 can be performed by gates or circuits associated with a processor, Application Specific Integrated Circuit (ASIC), a field programmable gate array (FPGA), a system on chip (SOC), a Neural Processing Unit (NPU), or other hardware device. Hereinafter, the method 300 shall be explained with reference to the systems, components, modules, software, data structures, user interfaces, etc. described in conjunction with FIGS. 1, 2, and 4-7.

The method 300 for generating a small language model includes a first training phase (e.g., operations 304-316) and a second training phase (e.g., operation 318-330). However, it should be appreciated that, as described in FIG. 1 above, the language model generator 240 may warm start the training of the small language model prior to performing the training phases of the method 300.

The method 300 starts at operation 302, where flow may proceed to 304. At operation 304, the language model generator 240 obtains a general dataset from various sources (e.g., web sources). The general dataset includes a plurality of general data.

At operation 306, the language model generator 240 annotates a subset of the general dataset based on one or more classifier metrics indicative of a quality of the subset of the general dataset. To do so, a subset of the general dataset is selected to represent the general dataset. Once the subset of the general dataset is selected, a generative transformer is used for annotations on the quality of the subset of the general dataset based on one or more classifier metrics. For example, the generative transformer may be a language model (e.g., a large language model) or any generative machine learning model capable of annotating data with specific attributes or features. The one or more classifier metrics are specific attributes or features associated with the subset of the general dataset. For example, the one or more classifier metrics include, but not limited to, factual knowledge, everyday knowledge, scientific knowledge, human behavior, toxicity, completeness, obscenity, obscurity, commonality, reasoning, promotional content, and/or unwanted content. In the illustrative embodiment, the language model generator 240 annotates each general data of the subset of the general dataset with a score for each classifier metric of the one or more classifier metrics using the generative transformer. For example, the score may be on a scale of one to ten with one being the lowest and ten being the highest. For example, a particular general data of the subset of the dataset may be annotated with 2/10 score for a toxicity level and 3/10 score for an obscenity level.

Upon annotating the subset of the general dataset, the language model generator 240 trains a classifier using the annotated subset of the general dataset as indicated in operation 308. The trained classifier is configured to predict quality of data based on the one or more classifier metrics. For example, the quality of data may be represented by a score for each classifier metric.

Subsequent to training the classifier, the language model generator 240 analyzes each general data of the general dataset as indicated in operation 310. Specifically, the language model generator 240 analyzes each general data to determine a score for each classifier metric associated with the respective general data using the trained classifier.

Based on the scores of the general data, the language model generator 240 generates one or more filters for filtering the general dataset as indicated in operation 312. Each filter indicates a threshold score for a respective classifier metric. In other words, the one or more filters may be used to filter the general dataset to select general data from the general dataset that have with certain attributes or features for training the small language model. For example, a toxicity filter may be defined with a threshold score for toxicity of content of 2/10. In other words, when the filter for toxicity is applied, any general data that has content that have a toxicity level higher than 2 will be filtered out, and only those general data that has content that have the toxicity level of 1 and 2 will remain.

Once the one or more filters are generated, the language model generator 240 generates a filtered general dataset as indicated in operation 314. Specifically, the language model generator 240 generates the filtered general dataset by filtering the general dataset using the one or more filters. The filtered general dataset is a subset of the general dataset that satisfies a predefined level of quality. As described above, each filter is associated with a respective classifier metric. In aspects, one or more filters are selected to obtain those general data that have certain attributes or features for training the small language model.

At operation 316, the language model generator 240 trains the small language model with the filtered general dataset. By curating the training data for the small language model, the small language model is trained with data that satisfies certain quality suitable for certain application. For example, the language model generator 240 may reduce toxic and biased content among the general dataset. Once the first training phase is performed, the small language model has general understanding of natural language.

Subsequently to the first training phase, the method 300 advances to the second training phase (e.g., operation 318-330). However, it should be appreciated that one or more operations from the second training phase for generating the synthetic dataset (e.g., 318-328) may be performed in parallel with one or more operations from the first training phase for generating the filtered general dataset (e.g., 304-314).

At operation 318, the language model generator 240 generates a synthetic dataset for refining the small language model. The synthetic dataset is “textbook-like” data that is created for the purposed of teaching common sense reasoning and general knowledge of the world (e.g., science, daily activities, theory of mind, etc.). For example, specific topics may be selected to seed the generation of the synthetic data.

To do so, at operation 320, the language model generator 240 identifies one or more deficit skills in the small language model. It should be appreciated that the term deficit skill means any skill or topic that may boost in the capability of the small language model.

At operation 322, the language model generator 240 determines one or more data formats to address the one or more deficit skills. For example, the data format may be texts, graphs, and/or images. At operation 324, the language model generator 240 obtains one or more prompts to create the one or more data formats. At operation 326, sources of randomization and diversity is injected in the one or more prompts.

As described above, the generative transformer is prompted to synthesize textbook-style content concerning the deficit skills that require to be boosted. For example, detailed lists of topics, subtopics, keywords, as well as content, related to those skills, that was filtered from other sources such as web pages may be provided and used as a seed to the generative transformer. The seed is shuffled and combined with styles, use-cases, user roles, and other sources of randomness that give rise to diverse ways of presenting the content. All of these may be combined as an input into the generative transformer's prompt in different random combinations.

At operation 328, the language model generator 240 generates the synthetic dataset based on the one or more prompts using a generative transformer. For example, the generative transformer may be any generative machine learning model (e.g., a large language model) capable of generating data based on a prompt. In aspects, the synthetic dataset is designed to provide and boost certain skills in the small language model.

Subsequently, at operation 320, the language model generator 240 trains the small language model with the synthetic dataset. Once the small language model went through the two-phase training, the small language model is adapted to understand common sense reasoning and general knowledge of the world for performing reasoning tasks (e.g., common sense or logical reasoning).

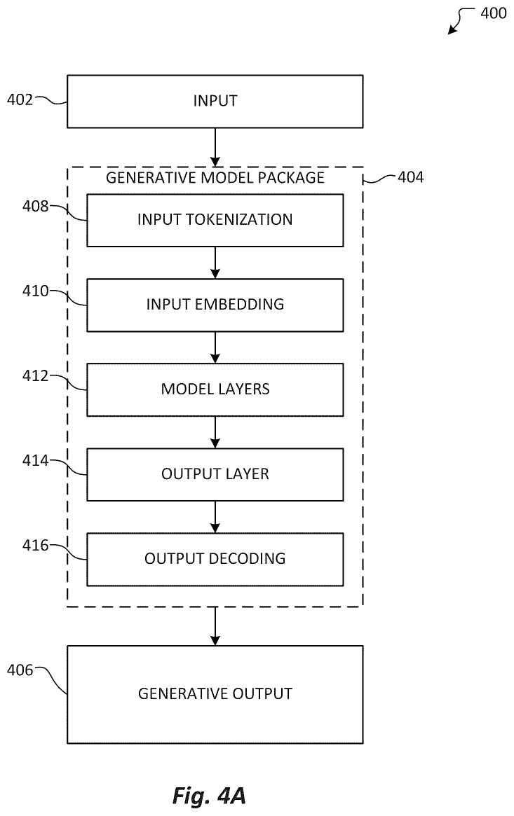

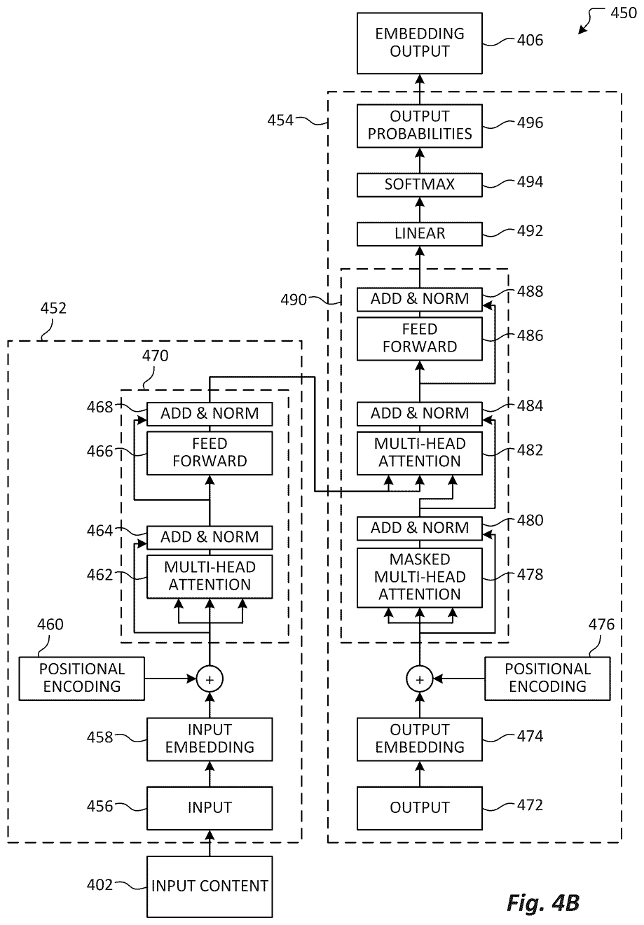

FIGS. 4A and 4B illustrate overviews of an example generative machine learning model that may be used according to aspects described herein. With reference first to FIG. 4A, conceptual diagram 400 depicts an overview of pre-trained generative model package 404 that processes an input 402 to generate model output for capturing and generatively transforming content items from a generative model output 406 according to aspects described herein.

In examples, generative model package 404 is pre-trained according to a variety of inputs (e.g., a variety of human languages, a variety of programming languages, and/or a variety of content types) and therefore need not be finetuned or trained for a specific scenario. Rather, generative model package 404 may be more generally pre-trained, such that input 402 includes a prompt that is generated, selected, or otherwise engineered to induce generative model package 404 to produce certain generative model output 406. It will be appreciated that input 402 and generative model output 406 may each include any of a variety of content types, including, but not limited to, text output, image output, audio output, video output, programmatic output, and/or binary output, among other examples. In examples, input 402 and generative model output 406 may have different content types, as may be the case when generative model package 404 includes a generative multimodal machine learning model.

As such, generative model package 404 may be used in any of a variety of scenarios and, further, a different generative model package may be used in place of generative model package 404 without substantially modifying other associated aspects (e.g., similar to those described herein with respect to FIGS. 1, 2, 3A, and 3B). Accordingly, generative model package 404 operates as a tool with which machine learning processing is performed, in which certain inputs 402 to generative model package 404 are programmatically generated or otherwise determined, thereby causing generative model package 404 to produce model output 406 that may subsequently be used for further processing.

Generative model package 404 may be provided or otherwise used according to any of a variety of paradigms. For example, generative model package 404 may be used local to a computing device (e.g., communication platform 102 in FIG. 1) or may be accessed remotely (e.g., client computing device 104 and/or 106). In other examples, aspects of generative model package 404 are distributed across multiple computing devices. In some instances, generative model package 404 is accessible via an API, as may be provided by an operating system of the computing device and/or by the machine learning service, among other examples.

With reference now to the illustrated aspects of generative model package 404, generative model package 404 includes input tokenization 408, input embedding 410, model layers 412, output layer 414, and output decoding 416. In examples, input tokenization 408 processes input 402 to generate input embedding 410, which includes a sequence of symbol representations that corresponds to input 402. Accordingly, input embedding 410 is processed by model layers 412, output layer 414, and output decoding 416 to produce model output 406. An example architecture corresponding to generative model package 404 is depicted in FIG. 4B, which is discussed below in further detail. Even so, it will be appreciated that the architectures that are illustrated and described herein are not to be taken in a limiting sense and, in other examples, any of a variety of other architectures may be used.

FIG. 4B is a conceptual diagram that depicts an example architecture 450 of a pre-trained generative machine learning model that may be used according to aspects described herein. As noted above, any of a variety of alternative architectures and corresponding ML models may be used in other examples without departing from the aspects described herein.

As illustrated, architecture 450 processes input 402 to produce generative model output 406, aspects of which were discussed above with respect to FIG. 4A. Architecture 450 is depicted as a transformer model that includes encoder 452 and decoder 454. Encoder 452 processes input embedding 458 (aspects of which may be similar to input embedding 410 in FIG. 4A), which includes a sequence of symbol representations that corresponds to input 456. In examples, input 456 includes input 402. Such aspects may be similar to those discussed above with respect to the language model generator 240 in FIG. 1, for example by performing aspects of methods 100 and/or 300 in FIGS. 1, 3A, and 3B, respectively.

Further, positional encoding 460 may introduce information about the relative and/or absolute position for tokens of input embedding 458. Similarly, output embedding 474 includes a sequence of symbol representations that correspond to output 472, while positional encoding 476 may similarly introduce information about the relative and/or absolute position for tokens of output embedding 474.

As illustrated, encoder 452 includes example layer 470. It will be appreciated that any number of such layers may be used, and that the depicted architecture is simplified for illustrative purposes. Example layer 470 includes two sub-layers: multi-head attention layer 462 and feed forward layer 466. In examples, a residual connection is included around each layer 462, 466, after which normalization layers 464 and 468, respectively, are included.

Decoder 454 includes example layer 490. Similar to encoder 452, any number of such layers may be used in other examples, and the depicted architecture of decoder 454 is simplified for illustrative purposes. As illustrated, example layer 490 includes three sub-layers: masked multi-head attention layer 478, multi-head attention layer 482, and feed forward layer 486. Aspects of multi-head attention layer 482 and feed forward layer 486 may be similar to those discussed above with respect to multi-head attention layer 462 and feed forward layer 466, respectively. Additionally, masked multi-head attention layer 478 performs multi-head attention over the output of encoder 452 (e.g., output 472). In examples, masked multi-head attention layer 478 prevents positions from attending to subsequent positions. Such masking, combined with offsetting the embeddings (e.g., by one position, as illustrated by multi-head attention layer 482), may ensure that a prediction for a given position depends on known output for one or more positions that are less than the given position. As illustrated, residual connections are also included around layers 478, 482, and 486, after which normalization layers 480, 484, and 488, respectively, are included.

Multi-head attention layers 462, 478, and 482 may each linearly project queries, keys, and values using a set of linear projections to a corresponding dimension. Each linear projection may be processed using an attention function (e.g., dot-product or additive attention), thereby yielding n-dimensional output values for each linear projection. The resulting values may be concatenated and once again projected, such that the values are subsequently processed as illustrated in FIG. 4B (e.g., by a corresponding normalization layer 464, 480, or 484).

Feed forward layers 466 and 486 may each be a fully connected feed-forward network, which applies to each position. In examples, feed forward layers 466 and 486 each include a plurality of linear transformations with a rectified linear unit activation in between. In examples, each linear transformation is the same across different positions, while different parameters may be used as compared to other linear transformations of the feed-forward network.

Additionally, aspects of linear transformation 492 may be similar to the linear transformations discussed above with respect to multi-head attention layers 462, 478, and 482, as well as feed forward layers 466 and 486. Softmax 494 may further convert the output of linear transformation 492 to predicted next-token probabilities, as indicated by output probabilities 496. It will be appreciated that the illustrated architecture is provided in as an example and, in other examples, any of a variety of other model architectures may be used in accordance with the disclosed aspects.

Accordingly, output probabilities 496 may thus form model output 406 according to aspects described herein, such that the output of the generative ML model (e.g., which may thus comprise generative content) is used, for example, as an introduction segment or as an outro segment of one or more communication participants according to aspects described herein.

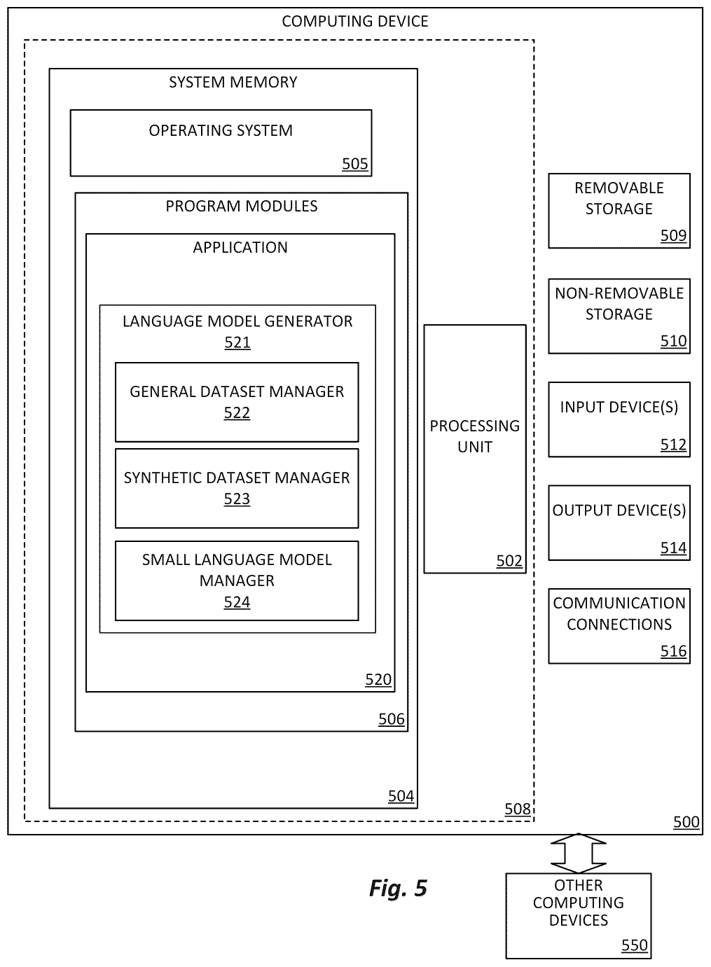

FIGS. 5-7 and the associated descriptions provide a discussion of a variety of operating environments in which aspects of the disclosure may be practiced. However, the devices and systems illustrated and discussed with respect to FIGS. 5-7 are for purposes of example and illustration and are not limiting of a vast number of computing device configurations that may be utilized for practicing aspects of the disclosure, described herein.

FIG. 5 is a block diagram illustrating physical components (e.g., hardware) of a computing device 500 with which aspects of the disclosure may be practiced. The computing device components described below may be suitable for the computing devices described above, including one or more devices associated with communication platform 102, as well as client computing devices 104 and/or 106 discussed above with respect to FIG. 1. In a basic configuration, the computing device 500 may include at least one processing unit 502 and a system memory 504. Depending on the configuration and type of computing device, the system memory 504 may comprise, but is not limited to, volatile storage (e.g., random access memory), non-volatile storage (e.g., read-only memory), flash memory, or any combination of such memories.

The system memory 504 may include an operating system 505 and one or more program modules 506 suitable for running software application 520, such as one or more components supported by the systems described herein. As examples, system memory 504 may include a language model generator 521, which further includes a general dataset manager 522, a synthetic dataset manager 523, and/or a small language model manager 524. The operating system 505, for example, may be suitable for controlling the operation of the computing device 500.

Furthermore, embodiments of the disclosure may be practiced in conjunction with a graphics library, other operating systems, or any other application program and is not limited to any particular application or system. This basic configuration is illustrated in FIG. 5 by those components within a dashed line 508. The computing device 500 may have additional features or functionality. For example, the computing device 500 may also include additional data storage devices (removable and/or non-removable) such as, for example, magnetic disks, optical disks, or tape. Such additional storage is illustrated in FIG. 5 by a removable storage device 509 and a non-removable storage device 510.

As stated above, a number of program modules and data files may be stored in the system memory 504. While executing on the processing unit 502, the program modules 506 (e.g., application 520) may perform processes including, but not limited to, the aspects, as described herein. Other program modules that may be used in accordance with aspects of the present disclosure may include electronic mail and contacts applications, word processing applications, spreadsheet applications, database applications, slide presentation applications, drawing or computer-aided application programs, etc.

Furthermore, embodiments of the disclosure may be practiced in an electrical circuit comprising discrete electronic elements, packaged or integrated electronic chips containing logic gates, a circuit utilizing a microprocessor, or on a single chip containing electronic elements or microprocessors. For example, embodiments of the disclosure may be practiced via a system-on-a-chip (SOC) where each or many of the components illustrated in FIG. 5 may be integrated onto a single integrated circuit. Such an SOC device may include one or more processing units, graphics units, communications units, system virtualization units and various application functionality all of which are integrated (or “burned”) onto the chip substrate as a single integrated circuit. When operating via an SOC, the functionality, described herein, with respect to the capability of client to switch protocols may be operated via application-specific logic integrated with other components of the computing device 500 on the single integrated circuit (chip). Embodiments of the disclosure may also be practiced using other technologies capable of performing logical operations such as, for example, AND, OR, and NOT, including but not limited to mechanical, optical, fluidic, and quantum technologies. In addition, embodiments of the disclosure may be practiced within a general purpose computer or in any other circuits or systems.

The computing device 500 may also have one or more input device(s) 512 such as a keyboard, a mouse, a pen, a sound or voice input device, a touch or swipe input device, etc. The output device(s) 514 such as a display, speakers, a printer, etc. may also be included. The aforementioned devices are examples and others may be used. The computing device 500 may include one or more communication connections 516 allowing communications with other computing devices 550. Examples of suitable communication connections 516 include, but are not limited to, radio frequency (RF) transmitter, receiver, and/or transceiver circuitry; universal serial bus (USB), parallel, and/or serial ports.

The term computer readable media as used herein may include computer storage media. Computer storage media may include volatile and nonvolatile, removable and non-removable media implemented in any method or technology for storage of information, such as computer readable instructions, data structures, or program modules. The system memory 504, the removable storage device 509, and the non-removable storage device 510 are all computer storage media examples (e.g., memory storage). Computer storage media may include RAM, ROM, electrically erasable read-only memory (EEPROM), flash memory or other memory technology, CD-ROM, digital versatile disks (DVD) or other optical storage, magnetic cassettes, magnetic tape, magnetic disk storage or other magnetic storage devices, or any other article of manufacture which can be used to store information and which can be accessed by the computing device 500. Any such computer storage media may be part of the computing device 500. Computer storage media does not include a carrier wave or other propagated or modulated data signal.

Communication media may be embodied by computer readable instructions, data structures, program modules, or other data in a modulated data signal, such as a carrier wave or other transport mechanism, and includes any information delivery media. The term “modulated data signal” may describe a signal that has one or more characteristics set or changed in such a manner as to encode information in the signal. By way of example, and not limitation, communication media may include wired media such as a wired network or direct-wired connection, and wireless media such as acoustic, radio frequency (RF), infrared, and other wireless media.

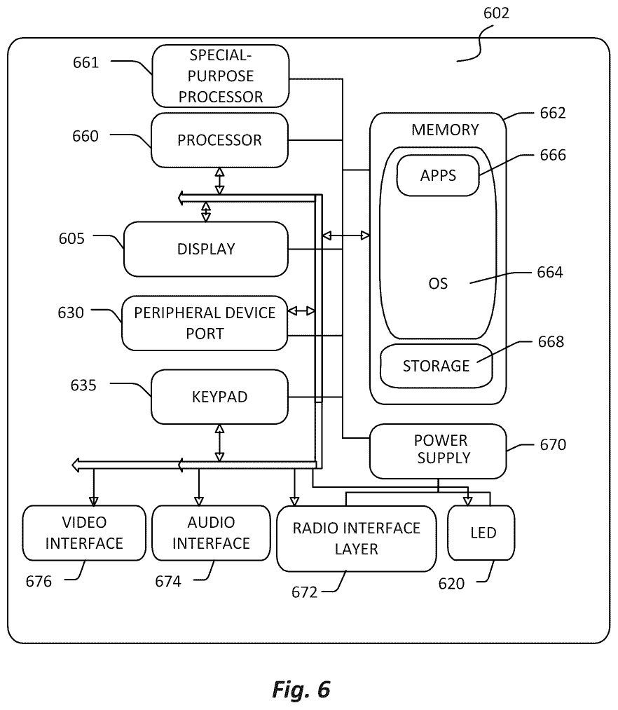

FIG. 6 illustrates a system 600 that may, for example, be a mobile computing device, such as a mobile telephone, a smart phone, wearable computer (such as a smart watch), a tablet computer, a laptop computer, and the like, with which embodiments of the disclosure may be practiced. In one embodiment, the system 600 is implemented as a “smart phone” capable of running one or more applications (e.g., browser, e-mail, calendaring, contact managers, messaging clients, games, and media clients/players). In some aspects, the system 600 is integrated as a computing device, such as an integrated personal digital assistant (PDA) and wireless phone.

In a basic configuration, such a mobile computing device is a handheld computer having both input elements and output elements. The system 600 typically includes a display 605 and one or more input buttons that allow the user to enter information into the system 600. The display 605 may also function as an input device (e.g., a touch screen display).

If included, an optional side input element allows further user input. For example, the side input element may be a rotary switch, a button, or any other type of manual input element. In alternative aspects, system 600 may incorporate more or less input elements. For example, the display 605 may not be a touch screen in some embodiments. In another example, an optional keypad 635 may also be included, which may be a physical keypad or a “soft” keypad generated on the touch screen display.

In various embodiments, the output elements include the display 605 for showing a graphical user interface (GUI), a visual indicator (e.g., a light emitting diode 620), and/or an audio transducer 625 (e.g., a speaker). In some aspects, a vibration transducer is included for providing the user with tactile feedback. In yet another aspect, input and/or output ports are included, such as an audio input (e.g., a microphone jack), an audio output (e.g., a headphone jack), and a video output (e.g., a HDMI port) for sending signals to or receiving signals from an external device.

One or more application programs 666 may be loaded into the memory 662 and run on or in association with the operating system 664. Examples of the application programs include phone dialer programs, e-mail programs, personal information management (PIM) programs, word processing programs, spreadsheet programs, Internet browser programs, messaging programs, and so forth. The system 600 also includes a non-volatile storage area 668 within the memory 662. The non-volatile storage area 668 may be used to store persistent information that should not be lost if the system 600 is powered down. The application programs 666 may use and store information in the non-volatile storage area 668, such as e-mail or other messages used by an e-mail application, and the like. A synchronization application (not shown) also resides on the system 600 and is programmed to interact with a corresponding synchronization application resident on a host computer to keep the information stored in the non-volatile storage area 668 synchronized with corresponding information stored at the host computer. As should be appreciated, other applications may be loaded into the memory 662 and run on the system 600 described herein.

The system 600 has a power supply 670, which may be implemented as one or more batteries. The power supply 670 might further include an external power source, such as an AC adapter or a powered docking cradle that supplements or recharges the batteries.

The system 600 may also include a radio interface layer 672 that performs the function of transmitting and receiving radio frequency communications. The radio interface layer 672 facilitates wireless connectivity between the system 600 and the “outside world,” via a communications carrier or service provider. Transmissions to and from the radio interface layer 672 are conducted under control of the operating system 664. In other words, communications received by the radio interface layer 672 may be disseminated to the application programs 666 via the operating system 664, and vice versa.

The visual indicator 620 may be used to provide visual notifications, and/or an audio interface 674 may be used for producing audible notifications via the audio transducer 625. In the illustrated embodiment, the visual indicator 620 is a light emitting diode (LED) and the audio transducer 625 is a speaker. These devices may be directly coupled to the power supply 670 so that when activated, they remain on for a duration dictated by the notification mechanism even though the processor 660 and other components might shut down for conserving battery power. The LED may be programmed to remain on indefinitely until the user takes action to indicate the powered-on status of the device. The audio interface 674 is used to provide audible signals to and receive audible signals from the user. For example, in addition to being coupled to the audio transducer 625, the audio interface 674 may also be coupled to a microphone to receive audible input, such as to facilitate a telephone conversation. In accordance with embodiments of the present disclosure, the microphone may also serve as an audio sensor to facilitate control of notifications, as will be described below. The system 600 may further include a video interface 676 that enables an operation of an on-board camera 630 to record still images, video stream, and the like.

It will be appreciated that system 600 may have additional features or functionality. For example, system 600 may also include additional data storage devices (removable and/or non-removable) such as, magnetic disks, optical disks, or tape. Such additional storage is illustrated in FIG. 6 by the non-volatile storage area 668.

Data/information generated or captured and stored via the system 600 may be stored locally, as described above, or the data may be stored on any number of storage media that may be accessed by the device via the radio interface layer 672 or via a wired connection between the system 600 and a separate computing device associated with the system 600, for example, a server computer in a distributed computing network, such as the Internet. As should be appreciated, such data/information may be accessed via the radio interface layer 672 or via a distributed computing network. Similarly, such data/information may be readily transferred between computing devices for storage and use according to any of a variety of data/information transfer and storage means, including electronic mail and collaborative data/information sharing systems.

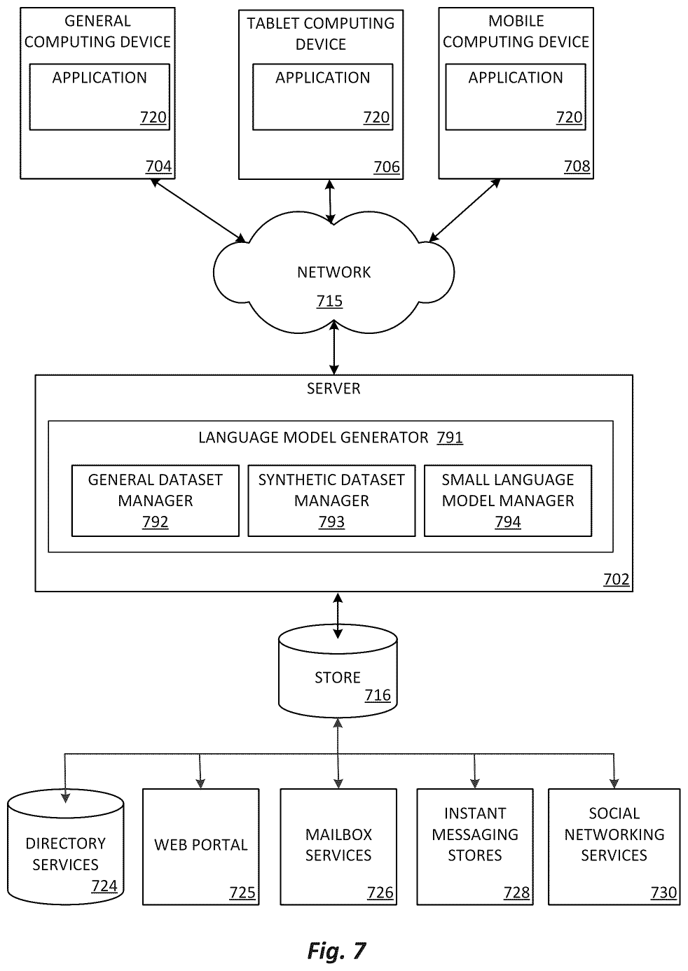

FIG. 7 illustrates one aspect of the architecture of a system for processing data received at a computing system from a remote source, such as a personal computer 704, tablet computing device 706, or mobile computing device 708, as described above. Content displayed at server device 702 may be stored in different communication channels or other storage types. For example, various documents may be stored using a directory service 724, a web portal 725, a mailbox service 726, an instant messaging store 728, or a social networking site 730.

An application 720 (e.g., similar to the application 520) may be employed by a client that communicates with server device 702. Additionally, or alternatively, a language model generator 791, a general dataset manager 792, a synthetic dataset manager 793, and/or a small language model manager 794 may be employed by server device 702. The server device 702 may provide data to and from a client computing device such as a personal computer 704, a tablet computing device 706 and/or a mobile computing device 708 (e.g., a smart phone) through a network 715. By way of example, the computer system described above may be embodied in a personal computer 704, a tablet computing device 706 and/or a mobile computing device 708 (e.g., a smart phone). Any of these examples of the computing devices may obtain content from the store 716, in addition to receiving graphical data useable to be either pre-processed at a graphic-originating system, or post-processed at a receiving computing system.

It will be appreciated that the aspects and functionalities described herein may operate over distributed systems (e.g., cloud-based computing systems), where application functionality, memory, data storage and retrieval and various processing functions may be operated remotely from each other over a distributed computing network, such as the Internet or an intranet. User interfaces and information of various types may be displayed via on-board computing device displays or via remote display units associated with one or more computing devices. For example, user interfaces and information of various types may be displayed and interacted with on a wall surface onto which user interfaces and information of various types are projected. Interaction with the multitude of computing systems with which embodiments of the invention may be practiced include, keystroke entry, touch screen entry, voice or other audio entry, gesture entry where an associated computing device is equipped with detection (e.g., camera) functionality for capturing and interpreting user gestures for controlling the functionality of the computing device, and the like.

Aspects of the present disclosure, for example, are described above with reference to block diagrams and/or operational illustrations of methods, systems, and computer program products according to aspects of the disclosure. The functions/acts noted in the blocks may occur out of the order as shown in any flowchart. For example, two blocks shown in succession may in fact be executed substantially concurrently or the blocks may sometimes be executed in the reverse order, depending upon the functionality/acts involved.

The description and illustration of one or more aspects provided in this application are not intended to limit or restrict the scope of the disclosure as claimed in any way. The aspects, examples, and details provided in this application are considered sufficient to convey possession and enable others to make and use claimed aspects of the disclosure. The claimed disclosure should not be construed as being limited to any aspect, example, or detail provided in this application. Regardless of whether shown and described in combination or separately, the various features (both structural and methodological) are intended to be selectively included or omitted to produce an aspect with a particular set of features. Having been provided with the description and illustration of the present application, one skilled in the art may envision variations, modifications, and alternate aspects falling within the spirit of the broader aspects of the general inventive concept embodied in this application that do not depart from the broader scope of the claimed disclosure.

In addition, the aspects and functionalities described herein may operate over distributed systems (e.g., cloud-based computing systems), where application functionality, memory, data storage and retrieval and various processing functions may be operated remotely from each other over a distributed computing network, such as the Internet or an intranet. User interfaces and information of various types may be displayed via on-board computing device displays or via remote display units associated with one or more computing devices. For example, user interfaces and information of various types may be displayed and interacted with on a wall surface onto which user interfaces and information of various types are projected. Interaction with the multitude of computing systems with which aspects of the disclosure may be practiced include, keystroke entry, touch screen entry, voice or other audio entry, gesture entry where an associated computing device is equipped with detection (e.g., camera) functionality for capturing and interpreting user gestures for controlling the functionality of the computing device, and the like.

The phrases “at least one,” “one or more,” “or,” and “and/or” are open-ended expressions that are both conjunctive and disjunctive in operation. For example, each of the expressions “at least one of A, B and C,” “at least one of A, B, or C,” “one or more of A, B, and C,” “one or more of A, B, or C,” “A, B, and/or C,” and “A, B, or C” means A alone, B alone, C alone, A and B together, A and C together, B and C together, or A, B and C together.

The term “a” or “an” entity refers to one or more of that entity. As such, the terms “a” (or “an”), “one or more,” and “at least one” can be used interchangeably herein. It is also to be noted that the terms “comprising,” “including,” and “having” can be used interchangeably.

The term “automatic” and variations thereof, as used herein, refers to any process or operation, which is typically continuous or semi-continuous, done without material human input when the process or operation is performed. However, a process or operation can be automatic, even though performance of the process or operation uses material or immaterial human input, if the input is received before performance of the process or operation. Human input is deemed to be material if such input influences how the process or operation will be performed. Human input that consents to the performance of the process or operation is not deemed to be “material.”

Any of the steps, functions, and operations discussed herein can be performed continuously and automatically.

The example systems and methods of this disclosure have been described in relation to computing devices. However, to avoid unnecessarily obscuring the present disclosure, the preceding description omits several known structures and devices. This omission is not to be construed as a limitation. Specific details are set forth to provide an understanding of the present disclosure. It should, however, be appreciated that the present disclosure may be practiced in a variety of ways beyond the specific detail set forth herein.

Furthermore, while the example aspects illustrated herein show the various components of the system collocated, certain components of the system can be located remotely, at distant portions of a distributed network, such as a LAN and/or the Internet, or within a dedicated system. Thus, it should be appreciated, that the components of the system can be combined into one or more devices, such as a server, communication device, or collocated on a particular node of a distributed network, such as an analog and/or digital telecommunications network, a packet-switched network, or a circuit-switched network. It will be appreciated from the preceding description, and for reasons of computational efficiency, that the components of the system can be arranged at any location within a distributed network of components without affecting the operation of the system.

Furthermore, it should be appreciated that the various links connecting the elements can be wired or wireless links, or any combination thereof, or any other known or later developed element(s) that is capable of supplying and/or communicating data to and from the connected elements. These wired or wireless links can also be secure links and may be capable of communicating encrypted information. Transmission media used as links, for example, can be any suitable carrier for electrical signals, including coaxial cables, copper wire, and fiber optics, and may take the form of acoustic or light waves, such as those generated during radio-wave and infra-red data communications.

While the flowcharts have been discussed and illustrated in relation to a particular sequence of events, it should be appreciated that changes, additions, and omissions to this sequence can occur without materially affecting the operation of the disclosed configurations and aspects.

Several variations and modifications of the disclosure can be used. It would be possible to provide for some features of the disclosure without providing others.

In yet another configurations, the systems and methods of this disclosure can be implemented in conjunction with a special purpose computer, a programmed microprocessor or microcontroller and peripheral integrated circuit element(s), an ASIC or other integrated circuit, a digital signal processor, a hard-wired electronic or logic circuit such as discrete element circuit, a programmable logic device or gate array such as PLD, PLA, FPGA, PAL, special purpose computer, any comparable means, or the like. In general, any device(s) or means capable of implementing the methodology illustrated herein can be used to implement the various aspects of this disclosure. Example hardware that can be used for the present disclosure includes computers, handheld devices, telephones (e.g., cellular, Internet enabled, digital, analog, hybrids, and others), and other hardware known in the art. Some of these devices include processors (e.g., a single or multiple microprocessors), memory, nonvolatile storage, input devices, and output devices. Furthermore, alternative software implementations including, but not limited to, distributed processing or component/object distributed processing, parallel processing, or virtual machine processing can also be constructed to implement the methods described herein.

In yet another configuration, the disclosed methods may be readily implemented in conjunction with software using object or object-oriented software development environments that provide portable source code that can be used on a variety of computer or workstation platforms. Alternatively, the disclosed system may be implemented partially or fully in hardware using standard logic circuits or VLSI design. Whether software or hardware is used to implement the systems in accordance with this disclosure is dependent on the speed and/or efficiency requirements of the system, the particular function, and the particular software or hardware systems or microprocessor or microcomputer systems being utilized.

In yet another configuration, the disclosed methods may be partially implemented in software that can be stored on a storage medium, executed on programmed general-purpose computer with the cooperation of a controller and memory, a special purpose computer, a microprocessor, or the like. In these instances, the systems and methods of this disclosure can be implemented as a program embedded on a personal computer such as an applet, JAVA® or CGI script, as a resource residing on a server or computer workstation, as a routine embedded in a dedicated measurement system, system component, or the like. The system can also be implemented by physically incorporating the system and/or method into a software and/or hardware system.

The disclosure is not limited to standards and protocols if described. Other similar standards and protocols not mentioned herein are in existence and are included in the present disclosure. Moreover, the standards and protocols mentioned herein, and other similar standards and protocols not mentioned herein are periodically superseded by faster or more effective equivalents having essentially the same functions. Such replacement standards and protocols having the same functions are considered equivalents included in the present disclosure.

In accordance with at least one example of the present disclosure, a method for generating a small language model is provided. The method may include obtaining a general dataset, the general dataset including a plurality of general data, annotating a subset of the general dataset based on one or more classifier metrics indicative of a quality of the general dataset, the subset of the general dataset being representative of the general dataset, training a classifier based on the annotated subset of the general dataset and the one or more classifier metrics, analyzing each general data of the general dataset to determine a score for each of the one or more classifier metrics associated with the respective general data using the trained classifier, generating a filtered general dataset by filtering the general dataset based on one or more filters, the one or more filters indicative of threshold scores for corresponding classifier metrics, training the small language model with the filtered general dataset, generating a synthetic dataset for refining the small language model, and subsequent to training the small language model with the filtered general dataset, training the small language model with the synthetic dataset.

In accordance with at least one aspect of the above method, the method may include where each general data of the general dataset is associated with a score for each of the one or more classifier metrics.

In accordance with at least one aspect of the above method, the method may include where the one or more classifier metrics comprise factual knowledge, everyday knowledge, scientific knowledge, human behavior, toxicity, completeness, obscenity, obscurity, commonality, reasoning, promotional content, and/or unwanted content.

In accordance with at least one aspect of the above method, the method may include where generating the filtered general dataset by filtering the general dataset based on the one or more filters comprises generating the one or more filters for the one or more classifier metrics, each filter corresponding to a respective classifier metric and indicative of a threshold score assigned for the respective classifier metric, and filtering the general dataset based on the one or more filters.

In accordance with at least one aspect of the above method, the method may include where generating a synthetic dataset for refining the small language model comprises identifying one or more deficit skills in the small language model, determining one or more data formats to address the one or more deficit skills, generating the one or more prompts for generating the one or more data formats, injecting sources of randomization and diversity in the one or more prompts, and generating the synthetic dataset based on the one or more prompts using a generative transformer, the synthetic dataset including the one or more data formats.

In accordance with at least one aspect of the above method, the method may include where the one or more deficit skills include any skill or topic for boosting the capability of the small language model.

In accordance with at least one aspect of the above method, the method may include where the generative transformer is a multimodal large language model.

In accordance with at least one aspect of the above method, the method may further include prior to training the small language model with the filtered general dataset, performing a warm start by copying weights from an existing trained model into the small language model.

In accordance with at least one example of the present disclosure, a computing device for generating a small language model is provided. The computing device may include a processor and a memory having a plurality of instructions stored thereon that, when executed by the processor, causes the computing device to generate a small language model, the method comprising: obtain a general dataset, the general dataset including a plurality of general data, annotate a subset of the general dataset based on one or more classifier metrics indicative of a quality of the general dataset, the subset of the general dataset being representative of the general dataset, train a classifier based on the annotated subset of the general dataset and the one or more classifier metrics, analyze each general data of the general dataset to determine a score for each of the one or more classifier metrics associated with the respective general data using the trained classifier, generate a filtered general dataset by filtering the general dataset based on one or more filters, the one or more filters indicative of threshold scores for corresponding classifier metrics, train the small language model with the filtered general dataset, generate a synthetic dataset for refining the small language model, and subsequent to training of the small language model with the filtered general dataset, train the small language model with the synthetic dataset.

In accordance with at least one aspect of the above computing device, the computing device may include where each general data of the general dataset is associated with a score for each of the one or more classifier metrics.

In accordance with at least one aspect of the above computing device, the computing device may include where the one or more classifier metrics comprise factual knowledge, everyday knowledge, scientific knowledge, human behavior, toxicity, completeness, obscenity, obscurity, commonality, reasoning, promotional content, and/or unwanted content.

In accordance with at least one aspect of the above computing device, the computing device may include where to generate the filtered general dataset by filtering the general dataset based on the one or more filters comprises to generate the one or more filters for the one or more classifier metrics, each filter corresponding to a respective classifier metric and indicative of a threshold score assigned for the respective classifier metric, and filter the general dataset based on the one or more filters.

In accordance with at least one aspect of the above computing device, the computing device may include where to generate a synthetic dataset for refining the small language model comprises to identify one or more deficit skills in the small language model, determine one or more data formats to address the one or more deficit skills, generate the one or more prompts for generating the one or more data formats, inject sources of randomization and diversity in the one or more prompts, and generate the synthetic dataset based on the one or more prompts using a generative transformer, the synthetic dataset including the one or more data formats.

In accordance with at least one aspect of the above computing device, the computing device may include where the one or more deficit skills include any skill or topic for boosting the capability of the small language model.

In accordance with at least one aspect of the above computing device, the computing device may include where the plurality of instructions, when executed, further cause the computing device to prior to training of the small language model with the filtered general dataset, perform a warm start by copying weights from an existing trained model into the small language model.

In accordance with at least one example of the present disclosure, a computer storage medium is provided. The computer storage medium stores computer-executable instructions that when executed cause at least one processor to perform operations. The operations include obtaining a general dataset, the general dataset including a plurality of general data, annotating a subset of the general dataset based on one or more classifier metrics indicative of a quality of the general dataset, the subset of the general dataset being representative of the general dataset, training a classifier based on the annotated subset of the general dataset and the one or more classifier metrics, analyzing each general data of the general dataset to determine a score for each of the one or more classifier metrics associated with the respective general data using the trained classifier, generating a filtered general dataset by filtering the general dataset based on one or more filters, the one or more filters indicative of threshold scores for corresponding classifier metrics, training the small language model with the filtered general dataset, generating a synthetic dataset for refining the small language model, and subsequent to training the small language model with the filtered general dataset, training the small language model with the synthetic dataset.

In accordance with at least one aspect of the above computer storage medium, the instructions may cause the computing device to perform a method where each general data of the general dataset is associated with a score for each of the one or more classifier metrics.

In accordance with at least one aspect of the above computer storage medium, the operations may further include where generating the filtered general dataset by filtering the general dataset based on the one or more filters comprises generating the one or more filters for the one or more classifier metrics, each filter corresponding to a respective classifier metric and indicative of a threshold score assigned for the respective classifier metric, and filtering the general dataset based on the one or more filters.

In accordance with at least one aspect of the above computer storage medium, the operations may further include where generating a synthetic dataset for refining the small language model comprises identifying one or more deficit skills in the small language model, determining one or more data formats to address the one or more deficit skills, generating the one or more prompts for generating the one or more data formats, injecting sources of randomization and diversity in the one or more prompts, and generating the synthetic dataset based on the one or more prompts using a generative transformer, the synthetic dataset including the one or more data formats. The one or more deficit skills may include any skill or topic for boosting the capability of the small language model.

In accordance with at least one aspect of the above computer storage medium, the operations may further include prior to training the small language model with the filtered general dataset, performing a warm start by copying weights from an existing trained model into the small language model.

Aspects of the present disclosure, for example, are described above with reference to block diagrams and/or operational illustrations of methods, systems, and computer program products according to aspects of the disclosure. The functions/acts noted in the blocks may occur out of the order as shown in any flowchart. For example, two blocks shown in succession may in fact be executed substantially concurrently or the blocks may sometimes be executed in the reverse order, depending upon the functionality/acts involved.

The description and illustration of one or more aspects provided in this application are not intended to limit or restrict the scope of the disclosure as claimed in any way. The aspects, examples, and details provided in this application are considered sufficient to convey possession and enable others to make and use claimed aspects of the disclosure. The claimed disclosure should not be construed as being limited to any aspect, example, or detail provided in this application. Regardless of whether shown and described in combination or separately, the various features (both structural and methodological) are intended to be selectively included or omitted to produce an embodiment with a particular set of features. Having been provided with the description and illustration of the present application, one skilled in the art may envision variations, modifications, and alternate aspects falling within the spirit of the broader aspects of the general inventive concept embodied in this application that do not depart from the broader scope of the claimed disclosure.

What is claimed is:

1. A method for generating a small language model, the method comprising:
obtaining a general dataset, the general dataset including a plurality of general data;
annotating a subset of the general dataset based on one or more classifier metrics indicative of a quality of the general dataset, the subset of the general dataset being representative of the general dataset;
training a classifier based on the annotated subset of the general dataset and the one or more classifier metrics;
analyzing each general data of the general dataset to determine a score for each of the one or more classifier metrics associated with the respective general data using the trained classifier;
generating a filtered general dataset by filtering the general dataset based on one or more filters, the one or more filters indicative of threshold scores for corresponding classifier metrics;
training the small language model with the filtered general dataset;
generating a synthetic dataset for refining the small language model; and
subsequent to training the small language model with the filtered general dataset, training the small language model with the synthetic dataset.

2. The method of claim 1, wherein each general data of the general dataset is associated with a score for each of the one or more classifier metrics.

3. The method of claim 1, wherein the one or more classifier metrics comprise factual knowledge, everyday knowledge, scientific knowledge, human behavior, toxicity, completeness, obscenity, obscurity, commonality, reasoning, promotional content, and/or unwanted content.

4. The method of claim 1, wherein generating the filtered general dataset by filtering the general dataset based on the one or more filters comprises:
generating the one or more filters for the one or more classifier metrics, each filter corresponding to a respective classifier metric and indicative of a threshold score assigned for the respective classifier metric; and
filtering the general dataset based on the one or more filters.

5. The method of claim 1, wherein generating a synthetic dataset for refining the small language model comprises:
identifying one or more deficit skills in the small language model;
determining one or more data formats to address the one or more deficit skills;
generating the one or more prompts for generating the one or more data formats;
injecting sources of randomization and diversity in the one or more prompts; and
generating the synthetic dataset based on the one or more prompts using a generative transformer, the synthetic dataset including the one or more data formats.

6. The method of claim 5, wherein the one or more deficit skills include any skill or topic for boosting the capability of the small language model.

7. The method of claim 5, wherein the generative transformer is a multimodal large language model.

8. The method of claim 1, further comprising:
prior to training the small language model with the filtered general dataset, performing a warm start by copying weights from an existing trained model into the small language model.

9. A computing device for generating a small language model, the computing device comprising:
a processor; and
a memory having a plurality of instructions stored thereon that, when executed by the processor, causes the computing device to:
generate a small language model, the method comprising:
obtain a general dataset, the general dataset including a plurality of general data;
annotate a subset of the general dataset based on one or more classifier metrics indicative of a quality of the general dataset, the subset of the general dataset being representative of the general dataset;
train a classifier based on the annotated subset of the general dataset and the one or more classifier metrics;
analyze each general data of the general dataset to determine a score for each of the one or more classifier metrics associated with the respective general data using the trained classifier;
generate a filtered general dataset by filtering the general dataset based on one or more filters, the one or more filters indicative of threshold scores for corresponding classifier metrics;
train the small language model with the filtered general dataset;
generate a synthetic dataset for refining the small language model; and
subsequent to training of the small language model with the filtered general dataset, train the small language model with the synthetic dataset.

10. The computing device of claim 9, wherein each general data of the general dataset is associated with a score for each of the one or more classifier metrics.

11. The computing device of claim 9, wherein the one or more classifier metrics comprise factual knowledge, everyday knowledge, scientific knowledge, human behavior, toxicity, completeness, obscenity, obscurity, commonality, reasoning, promotional content, and/or unwanted content.

12. The computing device of claim 9, wherein to generate the filtered general dataset by filtering the general dataset based on the one or more filters comprises to:
generate the one or more filters for the one or more classifier metrics, each filter corresponding to a respective classifier metric and indicative of a threshold score assigned for the respective classifier metric; and
filter the general dataset based on the one or more filters.

13. The computing device of claim 9, to generate a synthetic dataset for refining the small language model comprises to:
identify one or more deficit skills in the small language model;
determine one or more data formats to address the one or more deficit skills;
generate the one or more prompts for generating the one or more data formats;
inject sources of randomization and diversity in the one or more prompts; and
generate the synthetic dataset based on the one or more prompts using a generative transformer, the synthetic dataset including the one or more data formats.

14. The computing device of claim 13, wherein the one or more deficit skills include any skill or topic for boosting the capability of the small language model.

15. The computing device of claim 9, wherein the plurality of instructions, when executed, further cause the computing device to:
prior to training of the small language model with the filtered general dataset, perform a warm start by copying weights from an existing trained model into the small language model.

16. A computer storage medium storing computer-executable instructions that when executed cause at least one processor to perform operations, comprising:
obtaining a general dataset, the general dataset including a plurality of general data;
annotating a subset of the general dataset based on one or more classifier metrics indicative of a quality of the general dataset, the subset of the general dataset being representative of the general dataset;
training a classifier based on the annotated subset of the general dataset and the one or more classifier metrics;
analyzing each general data of the general dataset to determine a score for each of the one or more classifier metrics associated with the respective general data using the trained classifier;
generating a filtered general dataset by filtering the general dataset based on one or more filters, the one or more filters indicative of threshold scores for corresponding classifier metrics;
training the small language model with the filtered general dataset;
generating a synthetic dataset for refining the small language model; and
subsequent to training the small language model with the filtered general dataset, training the small language model with the synthetic dataset.

17. The computer storage medium of claim 16, wherein each general data of the general dataset is associated with a score for each of the one or more classifier metrics.

18. The computer storage medium of claim 16, wherein generating the filtered general dataset by filtering the general dataset based on the one or more filters comprises:
generating the one or more filters for the one or more classifier metrics, each filter corresponding to a respective classifier metric and indicative of a threshold score assigned for the respective classifier metric; and
filtering the general dataset based on the one or more filters.

19. The computer storage medium of claim 16, wherein generating a synthetic dataset for refining the small language model comprises:
identifying one or more deficit skills in the small language model;
determining one or more data formats to address the one or more deficit skills;
generating the one or more prompts for generating the one or more data formats;
injecting sources of randomization and diversity in the one or more prompts; and
generating the synthetic dataset based on the one or more prompts using a generative transformer, the synthetic dataset including the one or more data formats,
wherein the one or more deficit skills include any skill or topic for boosting the capability of the small language model.

20. The computer storage medium of claim 16, wherein the instructions when executed by the one or more processors further cause the computing device to perform the method comprising:
prior to training the small language model with the filtered general dataset, performing a warm start by copying weights from an existing trained model into the small language model.
